(19) United States
(12) Patent Application Publication
(10) Pub. No.: US 2024/0076528 A1
(43) Pub. Date: Mar. 7, 2024

(54) ADDITIVE COMPOSITION FOR FLAME RETARDANCY OF ADHESIVE, FLAME-RETARDANT ACRYLIC ADHESIVE, FLAME-RETARDANT TAPE USING THE SAME, AND MANUFACTURING METHOD THEREOF

(71) Applicant: AXEED Inc., Mokpo-si (KR)

(72) Inventors: Chang Ho LEE, Seoul (KR); Ki Hwan AN, Incheon (KR)

(21) Appl. No.: 18/241,351

(22) Filed: Sep. 1, 2023

(30) Foreign Application Priority Data
Sep. 5, 2022 (KR) 10-2022-0112379

(51) Int. Cl. C09J 11/06; C09J 11/08; C09J 133/08

(52) U.S. Cl. CPC C09J 11/06; C09J 11/08; C09J 133/08; C09J 2301/312; C09J 2301/408; C09J 2301/50

(57) ABSTRACT

An object of the invention is to provide a flame retardant coating composition that can be applied on the surface of a product to increase flame retardancy while maintaining adhesiveness. In order to achieve the above object, the first aspect of the invention may provide a flame retardant coating composition including a siloxane binder containing at least one of an epoxy group or a dimethyl group and a phenyl group, and a phosphorus-based flame retardant.

### BACKGROUND OF THE INVENTION

### 1. Field of the Invention

The present invention relates to an additive composition for imparting flame retardancy to an acrylic pressure-sensitive adhesive or adhesive, and more particularly, to a coating composition containing a siloxane binder and a phosphorus-based flame retardant.

### 2. Description of the Related Art

A pressure-sensitive adhesive or adhesive (adhesive) used in tapes and the like for attaching various products usually uses an acrylic composition. However, in the case of an acrylic material, it is difficult to implement flame retardancy by itself, and when a flame retardant is added thereto to implement flame retardancy, there is a problem in that pressure-sensitive adhesion or adhesiveness is significantly reduced, so that various attempts have been made to solve the problem, but it has been difficult to implement V-0 or VTM-0 according to UL94, which is a high flame retardant grade required by companies.

### SUMMARY OF THE INVENTION

The object of the present invention is to provide an additive composition for an adhesive, the composition capable of securing flame retardancy while maximally maintaining typical acrylic pressure-sensitive adhesion or adhesive strength.

In order to achieve the above object, according to the first aspect of the invention, there is provided a flame retardant additive composition for an acrylic adhesive, the composition including a siloxane binder containing a phenyl group and an epoxy group, and a phosphorus-based flame retardant.

In addition, in the flame retardant additive composition for an acrylic adhesive according to the first aspect of the invention, the siloxane binder may be prepared through a silane compound selected from the group consisting of phenylsilane, phenylmethylsilane, phenyltrimethoxysilane, phenyltriethoxysilane, diphenyldimethoxysilane, diphenyldiethoxysilane, diphenylsilanediol, triphenylsilanol, phenylmethyldimethoxysilane, phenylmethyldiethoxysilane, phenyltrichlorosilane, diphenyldichlorosilane, triphenylchlorosilane, phenylmethyldichlorosilane, and a combination thereof, and a silane compound selected from the group consisting of 3-glycidoxypropyl trimethoxy silane, 3-glycidoxypropyl triethoxy silane, 3-glycidoxypropyl methyldimethoxy silane, 3-glycidoxypropylmethyldiethoxy silane, 2-(3,4-epoxycyclohexyl)ethyl trimethoxy silane, 2-(3,4-epoxycyclohexyl)ethyl triethoxy silane, dimethyl dimethoxy silane, dimethyl diethoxy silane, and a combination thereof.

In addition, in the flame retardant additive composition for an acrylic adhesive according to the first aspect of the invention, the phosphorus-based flame retardant may be a phosphoric acid ester compound or a cyclic phosphate compound.

In addition, in the flame retardant additive composition for an acrylic adhesive according to the first aspect of the invention, the siloxane binder may be prepared by further containing tetraethoxysilane.

In addition, in the flame retardant additive composition for an acrylic adhesive according to the first aspect of the invention, the input weight of the phosphorus-based flame retardant may be 100 parts by weight to 300 parts by weight based on 100 parts by weight of the solid weight of the siloxane binder.

In addition, in the flame retardant additive composition for an acrylic adhesive according to the first aspect of the invention, the siloxane binder may be acidic.

In addition, in the flame retardant additive composition for an acrylic adhesive according to the first aspect of the invention, the siloxane binder may have a pH in the range of 3 to 6.

According to the second aspect of the invention, there is provided a flame retardant acrylic adhesive including the flame retardant additive composition for an acrylic adhesive in accordance with the first aspect of the invention.

According to the third aspect of the invention, there is provided a flame retardant adhesive tape manufactured by applying the flame retardant acrylic adhesive in accordance with the second aspect of the invention on at least one surface of a tape.

According to the fourth aspect of the invention, there is provided a method for manufacturing a flame retardant adhesive tape, the method including (a) preparing a silane solution by mixing a silane compound containing a phenyl group and a silane compound containing an epoxy group with a first solvent, (b) preparing an acidic silane solution by adding an acid to the silane solution, (c) preparing a first oligomer solution by heating the acidic silane solution, (d) preparing a siloxane binder by diluting the first oligomer solution with a second solvent, (e) preparing an additive composition for an acrylic adhesive by dissolving or mixing a phosphorus-based flame retardant into the siloxane binder, (f) preparing a flame retardant acrylic adhesive by mixing the additive composition for an acrylic adhesive with an acrylic adhesive, and (g) applying the flame retardant acrylic adhesive on at least one surface of a tape and curing the same.

In addition, in the method for manufacturing a flame retardant adhesive tape according to the fourth aspect of the invention, the curing in Step (g) above may be performed at room temperature.

### Advantageous Effects

It is possible to prepare an acrylic adhesive having excellent flame retardancy by using a flame retardant composition for an acrylic adhesive according to the invention, and also, it is possible to prepare an adhesive tape having excellent flame retardancy by using the same.

### DETAILED DESCRIPTION OF THE EXEMPLARY EMBODIMENTS

Hereinafter, the composition and operation of an embodiment of the invention will be described with reference to the accompanying drawings. In the following description of the invention, when it is determined that detailed descriptions of related known functions or configurations may unnecessarily obscure the gist of the invention, the detailed descriptions will be omitted. In addition, when a portion is said to ‘include’ any component, it means that the portion may further include other components rather than excluding the other components unless otherwise stated.

The invention may provide an additive composition for an acrylic adhesive for manufacturing an acrylic pressure-sensitive adhesive or adhesive tape, the composition including a siloxane binder containing a phenyl group and an epoxy group, and a phosphorus-based flame retardant.

In the case of a liquid acrylic adhesive, acryl by itself does not have any flame retardancy, so it is necessary to impart flame retardancy to the adhesive depending on some areas of use. A flame retardant to be added to impart flame retardancy includes a metal hydrate inorganic flame retardant, a halogen compound including bromine or chlorine, a phosphorus-based compound, a nitrogen-based compound, and the like. Compared to other flame retardants, the phosphorus-based compound is particularly eco-friendly, and thus, is actively being developed, but has a disadvantage of degraded heat resistance, so that there has been a problem in that the improvement in regard thereto is required.

The additive composition for an acrylic adhesive provided in the invention and including a siloxane binder may compensate for the degraded heat resistance in such a phosphorus-based flame retardant. Particularly, the siloxane binder in the invention is prepared through a silane compound containing a phenyl group and an epoxy group, and thus, contains the phenyl group and the epoxy group, and when compared to a typical siloxane binder, the siloxane binder containing the phenyl group and the epoxy group is combined with a phosphorus-based flame retardant, and thus, has excellent flame retardant properties when mixed with an acrylic adhesive, and at the same time, exhibits excellent pressure-sensitive adhesion or adhesive properties, and such pressure-sensitive adhesion or adhesive properties do not deteriorate over time, and there is no problem even when a typical pressure-sensitive adhesion or adhesive process is used.

The siloxane binder containing a phenyl group and an epoxy group is prepared by mixing and reacting a silane monomer into a solvent, and the silane monomer may include a silane compound selected from the group consisting of phenylsilane, phenylmethylsilane, phenyltrimethoxysilane, phenyltriethoxysilane, diphenyldimethoxysilane, diphenyldiethoxysilane, diphenylsilanediol, triphenylsilanol, phenylmethyldimethoxysilane, phenylmethyldiethoxysilane, phenyltrichlorosilane, diphenyldichlorosilane, triphenylchlorosilane, phenylmethyldichlorosilane, and a combination thereof, and a silane compound selected from the group consisting of 3-glycidoxypropyl trimethoxy silane, 3-glycidoxypropyl triethoxy silane, 3-glycidoxypropyl methyldimethoxy silane, 3-glycidoxypropylmethyldiethoxy silane, 2-(3,4-epoxycyclohexyl)ethyl trimethoxy silane, 2-(3,4-epoxycyclohexyl)ethyl triethoxy silane, dimethyl dimethoxy silane, dimethyl diethoxy silane, and a combination thereof.

In addition, a siloxane binder may be prepared by further adding tetraethoxysilane to the silane compound containing a phenyl group and an epoxy group and reacting the same, and since tetraethoxysilane is included, the molecular weight of the binder may be easily increased.

Meanwhile, the phosphorus-based flame retardant included in the coating composition provided in the invention may be a phosphoric acid ester compound or a cyclic phosphate compound. The phosphoric acid ester compound or the cyclic phosphate compound has a flame retardant mechanism in both a solid phase and a gas phase, so that a flame retardant effect may be effectively obtained. Therefore, as the phosphorus-based flame retardant, any one of the compounds or a combination of both of the compounds may be used.

In addition, in the coating composition provided in the invention, the input weight of the phosphorus-based flame retardant is preferably 100 parts by weight to 300 parts by weight based on 100 parts by weight of the solid weight of the siloxane binder containing a phenyl group.

In the coating composition provided by the invention, the input amount of the phosphorus-based flame retardant with respect to the siloxane binder containing a phenyl group and an epoxy group should be more than a predetermined amount so as to obtain flame retardant properties without affecting the pressure-sensitive adhesion or adhesive strength. It may be difficult to obtain effective and reproducible flame retardant properties if the weight of the phosphorus-based flame retardant is less than 100 parts by weight based on the weight of 100 parts by weight of the siloxane binder. In addition, if the weight of the phosphorus-based flame retardant is greater than 300 parts by weight based on the weight of 100 parts by weight of the siloxane binder, the viscosity of the coating composition may increase, thereby causing a decrease in pressure-sensitive adhesion or adhesiveness. Therefore, the weight of the phosphorus-based flame retardant may preferably be 100 parts by weight to 250 parts by weight, more preferably 150 parts by weight to 220 parts by weight, based on the weight of 100 parts by weight of the siloxane binder.

Here, the solid weight of the siloxane binder may be calculated by measuring the weight ratio of solids contained in the siloxane binder solution. The siloxane binder solution may be held in an oven at a high temperature for a long period of time to evaporate all the solvent and the weight of the remaining solids may be measured to confirm the solid weight ratio in the siloxane binder solution, through which the solid weight of the siloxane binder may be calculated.

In addition, in the additive composition for an adhesive provided in the invention, the siloxane binder containing a phenyl group and an epoxy group may be acidic.

It is preferable that the acidic siloxane binder has a pH in the range of 3 to 6. If the pH is too low, handling may become difficult or an object to be adhered or attached may be damaged, and if the pH is too high, there will be no significant difference in the curing rate in a final adhesive compared to a case in which the binder is neutral or basic.

In the invention, the flame retardant additive composition may be mixed with an acrylic adhesive to provide a flame retardant acrylic adhesive. The flame retardant acrylic adhesive according to the invention may be prepared by mixing 50 parts by weight to 100 parts by weight of the flame retardant additive composition for an acrylic adhesive based on the weight of 100 parts by weight of acrylic adhesive.

When the flame retardant composition is mixed in equal to or less than 50 parts by weight with respect to 100 parts by weight of the acrylic adhesive, it is difficult to secure flame retardancy of a final flame retardant acrylic adhesive, and when greater than 100 parts by weight, adhesion or adhesive properties are deteriorated.

In addition, it will be possible to manufacture a flame retardant acrylic adhesive tape through the flame retardant acrylic adhesive according to the invention. The flame retardant tape may be implemented by applying the above-described flame retardant acrylic adhesive on at least one surface of a tape, and aging the same. The flame retardant tape may exhibit excellent flame retardant properties while maximally maintaining typical adhesiveness, and thus, may be used in various fields of application.

In addition, the invention may provide a method for manufacturing a flame retardant adhesive tape. The method for manufacturing a flame retardant adhesive tape according to the invention may include preparing a silane solution by mixing a silane compound containing a phenyl group and a silane compound containing an epoxy group with a first solvent, preparing an acidic silane solution by adding an acid to the silane solution, preparing a first oligomer solution by heating the acidic silane solution, preparing a siloxane binder by diluting the first oligomer solution with a second solvent, preparing an additive composition by dissolving or mixing a phosphorus-based flame retardant into the siloxane binder, preparing a flame retardant acrylic adhesive by mixing the additive composition for an acrylic adhesive with an acrylic adhesive, and applying the flame retardant acrylic adhesive on at least one surface of a tape and curing the same.

Hereinafter, preferred embodiments of the invention will be described to facilitate sufficient understanding of the invention.

The embodiments of the invention are provided to more fully describe the invention to those people skilled in the art, and the following embodiments may be modified into various different forms, and the scope of the invention is not limited to the following embodiments. Rather, the embodiments are provided to make the present disclosure more thorough and complete, and to fully convey the idea of the invention to those skilled in the art.

### Example 1

<Preparation of Binder>

125.5 g of phenyltrimethoxysilane, 50.2 g of methyltriethoxysilane, 25.5 g of tetraethoxysilane, 45.5 g of 3-glysidoxypropyl trimethoxysilane, and 250 g of isopropanol were added to a three-neck flask equipped with a heating device and while the mixture was being stirred, a solution obtained by mixing 2 ml of nitric acid having a concentration of 0.01 mol/liter and 42 ml of pure water was added dropwise using a filter paper from a funnel installed in the flask for 30 minutes.

After the temperature of the contents in the flask reached 50° C. or lower, a reflux condenser was installed and during heating, reflux was performed at atmospheric pressure for 12 hours to obtain a siloxane binder solution containing a phenyl group and an epoxy group.

The binder solution was collected and diluted with tetrahydrofuran, and had a weight average molecular weight of approximately 1,500 when measured using tetrahydrofurane as a carrier and using a gel permeation chromatography device having a refractive index detector attached thereto.

<Preparation of Flame Retardant Composition>

To the synthesized siloxane binder solution, 50 parts by weight, 100 parts by weight, 150 parts by weight, 200 parts by weight, 250 parts by weight, and 300 parts by weight of a phosphoric acid ester-based flame retardant were respectively added based on 100 parts by weight of the solid weight of the binder, and then mixed with an acrylic adhesive to prepare a coating composition. The solid weight of the binder was calculated through the weight of the remaining solids after keeping the binder solution for 12 hours in an oven with an internal temperature of 100° C.

<Preparation of Flame Retardant Acrylic Adhesive>

The resulting flame retardant composition was added and mixed into a typical acrylic adhesive. The input amount thereof was 75 parts by weight based on 100 parts by weight of the acrylic adhesive.

<Evaluation>

The resulting flame retardant acrylic adhesive was coated on a PET film having a thickness of 4 μm to 5 μm with a bar coater, dried for about 10 seconds using a dryer, and aged for 48 hours in an oven at 120 degrees to maximize the adhesive effect. The coated tape was allowed to have a thickness between 10 μm to 13 μm, and both surfaces thereof were coated.

For the coated film, the flame retardancy was evaluated in accordance with the UL94 V-2, V-1, V-0, and V5 certification methods, and the adhesiveness test was conducted to determine how much the adhesive strength was degraded based on an acrylic adhesive not containing the flame retardant composition.

### Example 2

<Preparation of Binder>

125.5 g of phenyltrimethoxysilane, 50.2 g of methyltriethoxysilane, 25.5 g of tetraethoxysilane, 21.5 g of 3-glysidoxypropyl trimethoxysilane, and 220 g of isopropanol were added to a three-neck flask equipped with a heating device and while the mixture was being stirred, a solution obtained by mixing 2 ml of nitric acid having a concentration of 0.01 mol/liter and 42 ml of pure water was added dropwise using a filter paper from a funnel installed in the flask for 30 minutes.

After the temperature of the contents in the flask reached 50° C. or lower, a reflux condenser was installed and during heating, reflux was performed at atmospheric pressure for 12 hours to obtain a siloxane binder solution containing a phenyl group and an epoxy group.

The binder solution was collected and diluted with tetrahydrofuran, and had a weight average molecular weight of approximately 1,700 when measured using tetrahydrofurane as a carrier and using a gel permeation chromatography device having a refractive index detector attached thereto.

Hereinafter, the preparation of a flame retardant composition, and the preparation and evaluation of a flame retardant acrylic adhesive were performed in the same manner as in Example 1.

### Comparative Example 1

<Preparation of Binder>

125.5 g of phenyltrimethoxysilane, 50.2 g of methyltriethoxysilane, 45.2 g of tetraethoxysilane, and 220 g of isopropanol were added to a three-neck flask equipped with a heating device and while the mixture was being stirred, a solution obtained by mixing 2 ml of nitric acid having a concentration of 0.01 mol/liter and 42 ml of pure water was added dropwise using a filter paper from a funnel installed in the flask for 30 minutes.

After the temperature of the contents in the flask reached 50° C. or lower, a reflux condenser was installed and during heating, reflux was performed at atmospheric pressure for 12 hours to obtain a siloxane binder solution containing a phenyl group.

The binder solution was collected and diluted with tetrahydrofuran, and had a weight average molecular weight of approximately 2,700 when measured using tetrahydrofurane as a carrier and using a gel permeation chromatography device having a refractive index detector attached thereto.

Hereinafter, the preparation of a flame retardant composition, and the preparation and evaluation of a flame retardant acrylic adhesive were performed in the same manner as in Example 1.

### Comparative Example 2

<Preparation of Binder>

125.5 g of phenyltrimethoxysilane, 50.2 g of methyltriethoxysilane, 25.5 g of tetraethoxysilane, 50.7 g of 3-methacryloxypropyl trimethoxy silane, and 250 g of isopropanol were added to a three-neck flask equipped with a heating device and while the mixture was being stirred, a solution obtained by mixing 2 ml of nitric acid having a concentration of 0.01 mol/liter and 32 ml of pure water was added dropwise using a filter paper from a funnel installed in the flask for 30 minutes.

After the temperature of the contents in the flask reached 50° C. or lower, a reflux condenser was installed and during heating, reflux was performed at atmospheric pressure for 12 hours to obtain a siloxane binder solution containing a phenyl group.

The binder solution was collected and diluted with tetrahydrofuran, and had a weight average molecular weight of approximately 2,500 when measured using tetrahydrofurane as a carrier and using a gel permeation chromatography device having a refractive index detector attached thereto.

Hereinafter, the preparation of a flame retardant composition, and the preparation and evaluation of a flame retardant acrylic adhesive were performed in the same manner as in Example 1.

### Comparative Example 3

<Preparation of Binder>

125.5 g of phenyltrimethoxysilane, 50.2 g of methyltriethoxysilane, 25.5 g of tetraethoxysilane, 25.7 g of vinyltrimethoxysilane, and 220 g of isopropanol were added to a three-neck flask equipped with a heating device and while the mixture was being stirred, a solution obtained by mixing 2 ml of nitric acid having a concentration of 0.01 mol/liter and 42 ml of pure water was added dropwise using a filter paper from a funnel installed in the flask for 30 minutes.

After the temperature of the contents in the flask reached 50° C. or lower, a reflux condenser was installed and during heating, reflux was performed at atmospheric pressure for 12 hours to obtain a siloxane binder solution containing a phenyl group.

The binder solution was collected and diluted with tetrahydrofuran, and had a weight average molecular weight of approximately 2,300 when measured using tetrahydrofurane as a carrier and using a gel permeation chromatography device having a refractive index detector attached thereto.

Hereinafter, the preparation of a flame retardant composition, and the preparation and evaluation of a flame retardant acrylic adhesive were performed in the same manner as in Example 1.

### Comparative Example 4

A flame retardant composition and a flame retardant acrylic adhesive were prepared in the same manner as in Example 1 by using a typical epoxy binder commonly used, and the flame retardancy and adhesiveness were confirmed.

### Comparative Example 5

An acrylic adhesive was prepared by adding a phosphoric acid ester-based flame retardant in the same amount as in Example 1 to a typical acrylic adhesive commonly used, and the flame retardancy and adhesiveness were confirmed.

The flame retardancy test results for the films made through Examples 1 to 2 and Comparative Examples 1 to 5 are shown in the table below.

TABLE 1

| | Input amount of flame retardant | | | | | |
|---|---|---|---|---|---|---|
| | 50 parts by | 100 parts by | 150 parts by | 200 parts by | 250 parts by | 300 parts by |
| | weight | weight | weight | weight | weight | weight |
| Example 1 | Flame | Flame | Flame | Flame | Flame | Flame |
| | retardancy | retardancy | retardancy | retardancy | retardancy | retardancy |
| | V-1 | V-0 | V-0 | V-0 | V-0 | V-0 |
| | Adhesiveness | Adhesiveness | Adhesiveness | Adhesiveness | Adhesiveness | Adhesiveness |
| | OK | OK | OK | OK | decreased by | decreased by |
| | | | | | 10% | 20% |
| Example 2 | Flame | Flame | Flame | Flame | Flame | Flame |
| | retardancy | retardancy | retardancy | retardancy | retardancy | retardancy |
| | V-1 | V-1 | V-1 | V-0 | V-0 | V-0 |
| | Adhesiveness | Adhesiveness | Adhesiveness | Adhesiveness | Adhesiveness | Adhesiveness |
| | OK | OK | OK | decreased by | decreased by | decreased by |
| | | | | 7% | 15% | 30% |
| Comparative | Flame | Flame | Flame | Flame | Flame | Flame |
| Example 1 | retardancy | retardancy | retardancy | retardancy | retardancy | retardancy |
| | V-2 | V-2 | V-2 | V-2 | V-2 | V-2 |
| | Adhesiveness | Adhesiveness | Adhesiveness | Adhesiveness | Adhesiveness | Adhesiveness |
| | decreased by | decreased by | decreased by | decreased by | decreased by | decreased by |
| | 5% | 10% | 15% | 25% | 35% | 45% |
| Comparative | No flame | No flame | Flame | Flame | Flame | Flame |
| Example 2 | retardancy | retardancy | retardancy | retardancy | retardancy | retardancy |
| | performance | performance | V-2 | V-2 | V-2 | V-2 |
| | Adhesiveness | Adhesiveness | Adhesiveness | Adhesiveness | Adhesiveness | Adhesiveness |
| | OK | OK | OK | decreased by | decreased by | decreased by |
| | | | | 10% | 20% | 30% |
| Comparative | No flame | No flame | No flame | Flame | Flame | Flame |
| Example 3 | retardancy | retardancy | retardancy | retardancy | retardancy | retardancy |
| | performance | performance | performance | V-2 | V-2 | V-2 |
| | Adhesiveness | Adhesiveness | Adhesiveness | Adhesiveness | Adhesiveness | Adhesiveness |
| | OK | OK | decreased by | decreased by | decreased by | decreased by |
| | | | 7% | 10% | 20% | 30% |
| Comparative | No flame | No flame | No flame | No flame | No flame | No flame |
| Example 4 | retardancy | retardancy | retardancy | retardancy | retardancy | retardancy |
| | performance | performance | performance | performance | performance | performance |
| | Adhesiveness | Adhesiveness | Adhesiveness | Adhesiveness | Adhesiveness | Adhesiveness |
| | OK | OK | OK | decreased by | decreased by | decreased by |
| | | | | 7% | 15% | 25% |
| Comparative | No flame | No flame | No flame | No flame | No flame | No flame |
| Example 5 | retardancy | retardancy | retardancy | retardancy | retardancy | retardancy |
| | performance | performance | performance | performance | performance | performance |
| | Adhesiveness | Adhesiveness | Adhesiveness | Adhesiveness | Adhesiveness | Adhesiveness |
| | OK | OK | decreased by | decreased by | decreased by | decreased by |
| | | | 9% | 15% | 25% | 40% |

As in the flame retardancy and adhesiveness test results shown in the table above, stable flame retardancy and adhesiveness results were obtained in Examples 1 to 2 according to the invention, but in Comparative Examples, it was confirmed that despite the addition of a flame retardant, a desired level of flame retardancy performance was not achieved, or the adhesiveness was poor when the flame retardancy was achieved.

1. A flame retardant additive composition for an acrylic adhesive, the composition comprising a siloxane binder containing a phenyl group and an epoxy group, and a phosphorus-based flame retardant.

2. The flame retardant additive composition of claim 1,
wherein the siloxane binder is prepared through:
a silane compound selected from the group consisting of phenylsilane, phenylmethylsilane, phenyltrimethoxysilane, phenyltriethoxysilane, diphenyldimethoxysilane, diphenyldiethoxysilane, diphenylsilanediol, triphenylsilanol, phenylmethyldimethoxysilane, phenylmethyldiethoxysilane, phenyltrichlorosilane, diphenyldichlorosilane, triphenylchlorosilane, phenylmethyldichlorosilane, and a combination thereof; and
a silane compound selected from the group consisting of 3-glycidoxypropyl trimethoxy silane, 3-glycidoxypropyl triethoxy silane, 3-glycidoxypropyl methyldimethoxy silane, 3-glycidoxypropylmethyldiethoxy silane, 2-(3,4-epoxycyclohexyl)ethyl trimethoxy silane, 2-(3,4-epoxycyclohexyl)ethyl triethoxy silane, dimethyl dimethoxy silane, dimethyl diethoxy silane, and a combination thereof.

3. The flame retardant additive composition of claim 1,
wherein the phosphorus-based flame retardant is a phosphoric acid ester compound or a cyclic phosphate compound.

4. The flame retardant additive composition of claim 1,
wherein the siloxane binder is prepared by further containing tetraethoxysilane.

5. The flame retardant additive composition of claim 1,
wherein the input weight of the phosphorus-based flame retardant is 100 parts by weight to 300 parts by weight based on 100 parts by weight of the solid weight of the siloxane binder.

6. The flame retardant additive composition of claim 1,
wherein the siloxane binder is acidic.

7. The flame retardant additive composition of claim 6,
wherein the siloxane binder has a pH in the range of 3 to 6.

8. A flame retardant acrylic adhesive comprising the flame retardant composition in accordance with claim 1.

9. A flame retardant adhesive tape manufactured by applying the flame retardant acrylic adhesive in accordance with claim 8 on at least one surface of a tape.

10. A method for manufacturing a flame retardant adhesive tape, the method comprising:
(a) preparing a silane solution by mixing a silane compound containing a phenyl group and a silane compound containing an epoxy group with a first solvent;
(b) preparing an acidic silane solution by adding an acid to the silane solution;
(c) preparing a first oligomer solution by heating the acidic silane solution;
(d) preparing a siloxane binder by diluting the first oligomer solution with a second solvent;
(e) preparing an additive composition for an acrylic adhesive by dissolving or mixing a phosphorus-based flame retardant into the siloxane binder;
(f) preparing a flame retardant acrylic adhesive by mixing the additive composition for an acrylic adhesive with an acrylic adhesive; and
(g) applying the flame retardant acrylic adhesive on at least one surface of a tape and curing the same.

11. The method of claim 10,
wherein the curing in Step (g) above is performed at room temperature.
